(19) United States
(12) Patent Application Publication
(10) Pub. No.: US 2026/0120167 A1
(43) Pub. Date: Apr. 30, 2026

(54) USING A LARGE LANGUAGE MODEL FOR ALTERNATIVE INGREDIENT DETERMINATION

(71) Applicant: Maplebear Inc., San Francisco, CA (US)

(72) Inventors: Naval Shah, Toronto (CA); Riddhima Sejpal, Dublin, CA (US)

(21) Appl. No.: 18/933,820

(22) Filed: Oct. 31, 2024

(51) Int. Cl. G06Q 30/0601; G06F 3/0482; G06F 40/205

(52) U.S. Cl. CPC G06Q 30/0631; G06F 3/0482; G06F 40/205; G06Q 30/0633

(57) ABSTRACT

Leveraging a large language model for alternative ingredient determination is described. An online system receives, from a user device, an instruction to determine an alternative ingredient. An alternative ingredient is different from an ingredient of a recipe but has a common purpose with the ingredient in a context of the recipe. A large language model is prompted, based in part on the instruction, to determine one or more alternative ingredients for the ingredient of the recipe. An output of the large language model includes the one or more alternative ingredients. The output is processed, and at least some of the processed output is provided to the user device, and the user device presents at least one of the one or more alternative ingredients to the ingredient.

### BACKGROUND

Current approaches for online shopping platforms sometimes provide recipes for various meals. And once a recipe is selected, the online shopping platform may display products corresponding to the ingredients for the recipe. In some cases, a user may wish to substitute out ingredients of the recipe (e.g., if the user is a vegan and looking at a non-vegan recipe). But conventional online shopping platforms may present a fixed set of items that are used in the recipe and might not allow a user to substitute an ingredient (e.g., eggs) for an alternative ingredient (e.g., apple sauce) that performs the same function within the context of the recipe. Accordingly, if a user would like to use an alternative ingredient in the recipe (e.g., chicken instead of beef), the user is left to manually search for the ingredient and estimate not only how much of the alternative ingredient to use, but also how use of the alternative ingredient would affect the recipe as a whole.

### SUMMARY

In accordance with one or more aspects of the disclosure, leveraging a large language model for alternative ingredient determination is described. Alternative ingredient determination may be for a specific ingredient of a recipe or as part of an adjustment of a recipe to a different type (e.g., making a recipe vegan). An online system receives, from a user device, an instruction to determine an alternative ingredient that is different from an ingredient of a recipe but has a common purpose (e.g., both are used as a binding agent in a recipe for a baked good) with the ingredient in a context of the recipe. In some embodiments, the instruction includes an instruction to change the recipe to a different type.

The online system may prompt, based in part on the instruction, a large language model to determine one or more alternative ingredients for the ingredient of the recipe. In some embodiments (e.g., based in part on the instruction), the prompt may request the large language model to adjust the recipe to be of the different type. The large language model outputs recipe data that includes the one or more alternative ingredients, and may also include other information (e.g., updated ingredient list, updated preparation steps, etc.) specific to changing the recipe to the different type.

The online system processes the output of the large language model. For example, the online system may identify food item(s) in an online catalog that correspond to the one or more alternative ingredients. The online system may generate ingredient recommendation(s) using the food item(s) corresponding to the one or more alternative ingredients and the recipe data.

The online system provides at least some of the processed output (e.g., food item(s) or ingredient recommendation(s) corresponding to at least one of the one or more alternative ingredients) to the user device. The user device presents at least one of the one or more alternative ingredients (e.g., as part of a corresponding ingredient recommendation) in lieu of the ingredient. The user may add the food item corresponding to the alternative ingredient to an ordering list for purchase via the online system. In this manner, a user of the user device is able to use the online system to quickly customize the recipe prior to adding food items for the customized recipe to an ordering list for purchase.

The online system may also use past user interactions with suggested substitute ingredients to tune the large language model. The large language model may be trained by, e.g., accessing a set of training examples including previous prompts and the suggested substitute ingredient. The online system may then re-train the large language model using the previous prompts as the prefix and a user-confirmed substitute item as the suffix for training the parameters of the large language model. Alternatively, the online system may use the training examples for prompt-tuning the large language model, for example by including in subsequent prompts the training examples as positive and negative examples for substitute ingredients. The online system may back-propagate one or more error terms obtained from one or more loss functions to update a set of parameters of the large language model, and one or more of the error terms are based on a difference between a label applied to a test interaction of the set of training examples and the set of predicted alternative ingredients. The online system may stop the back-propagation after the one or more loss functions satisfy one or more criteria.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIGS. 3A-3B form an example sequence diagram describing leveraging a large language model for alternative ingredient determination, in accordance with some embodiments.

FIG. 4A illustrates an example ordering interface associated with a recipe, in accordance with some embodiments.

FIG. 4B illustrates the ordering interface of FIG. 4A after selection of a recipe type change option.

FIG. 4C illustrates the ordering interface of FIG. 4A after selection of an alternative ingredient request option.

FIG. 5 is a flowchart for a method of leveraging a large language model for alternative ingredient determination, in accordance with some embodiments.

### DETAILED DESCRIPTION

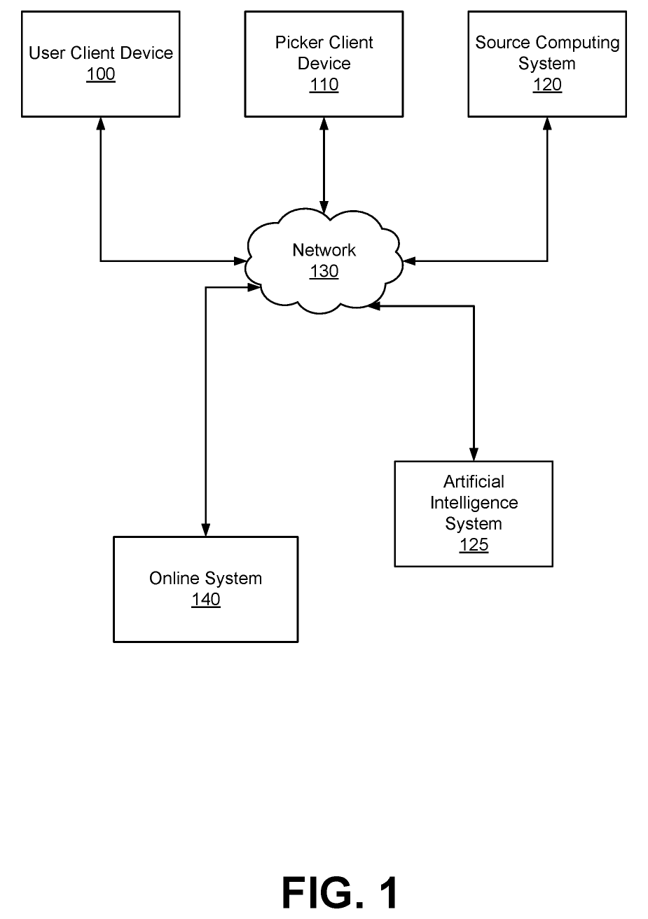

FIG. 1 illustrates an example system environment for an online system 140, in accordance with one or more embodiments. The system environment illustrated in FIG. 1 includes a user client device 100, a picker client device 110, a source computing system 120, an artificial intelligence (AI) system 125, a network 130, and an online system 140. Alternative embodiments may include more, fewer, or different components from those illustrated in FIG. 1, and the functionality of each component may be divided between the components differently from the description below. For example, some or all of the functionality of the AI system 125 may be performed by the online system 140. Additionally, each component may perform their respective functionalities in response to a request from a human, or automatically without human intervention.

Although one user client device 100, picker client device 110, source computing system 120, and AI system 125 are illustrated in FIG. 1, any number of users, pickers, sources, and AI systems may interact with the online system 140. As such, there may be more than one user client device 100, picker client device 110, source computing system 120, or AI system 125. The user client device 100 or the picker client device 110 may be rereferred to as a "user device."

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

A “food item” is an item that is a nourishing substance that may be eaten or drunk. A recipe is a set of directions for preparing one or more ingredients to obtain a preparation of a nourishing substance. A recipe may be described using recipe data. Recipe data for a recipe may include, e.g., preparation steps of the recipe, ingredients of the recipe, name of the recipe, type of the recipe, and other information like, e.g., recipe description, preparation time, calories, images associated with the recipe, etc.

An alternative ingredient is different from an ingredient of a recipe but has a common purpose with the ingredient in a context of the recipe. For example, a recipe may be for a baked good, that uses eggs (ingredient) as a binding agent (purpose of ingredient). In the context of this recipe for the baked good, an alternative ingredient may be apple sauce as it is different from eggs, but also may act as a binding agent in the context of the recipe for the baked good. Another example would be a recipe for hamburgers. A recipe for hamburgers may call for ground beef, where the purpose of ground beef may be to be the main protein. An alternative ingredient for ground beef may be, e.g., ground turkey, ground chicken, plant based protein, etc. - all of which are different from ground beef but also serve as the purpose of being the main protein in the context of the recipe.

A "type" of the recipe describes a diet category of the recipe. For example, a type may be vegan, vegetarian, pescatarian, gluten-free, dairy-free, low-sodium, low-cholesterol, paleo, some other diet category, or some combination thereof. In some embodiments, a recipe may have a plurality of different types (e.g., low-sodium and vegan). A type of a recipe is based on the ingredients used in the recipe. As such, substituting one or more ingredients of a recipe with corresponding one or more alternative ingredients may change the type of the recipe to a different type.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

An interface (e.g., the ordering interface) of the user client device 100 presents one or more recipes to the user. The interface may present recipes from the online system 140, one or more third party systems (not shown) coupled to the user client device 100 via the network 130, or some combination thereof. The user may search or browse recipes via the interface. Responsive to selection of a recipe, the user client device 100 may present, e.g., items (e.g., food items) corresponding to ingredients of the recipe, preparation steps of the recipe, a description of the recipe, a type of the recipe, etc.

The interface may include one or more options to request alternative ingredients for one or more ingredients of a recipe being presented. In some embodiments, the interface may enable the user to select a plurality of ingredients to request alternative ingredients for via selection of a single option. For example, the one or more options may be hyperlinks (or soft button, etc.) for requesting alternative ingredients. Responsive to selection of an option associated with an ingredient, the user client device 100 may send an instruction to the online system 140 to determine an alternative ingredient that is different from the ingredient but has a common purpose with the ingredient in a context of the recipe. The user client device 100 receives one or more alternative ingredients for the ingredients, and presents (e.g., via the ordering interface) the alternative ingredients.

For example, an ingredient of a recipe may include lemon zest for acid (purpose). Responsive to selection of the hyperlink, the user client device 100 instructs the online system 140 to determine an alternative ingredient that is different from lemon zest used in the recipe but has a common purpose with lemon zest in a context of the recipe. The user client device 100 may receive one or more alternative ingredients (e.g., grapefruit zest) and present (e.g., via the ordering interface) at least one (e.g., highest ranked) of the one or more alternative ingredients to the user. In this manner, a user may easily swap out individual ingredients of a recipe to their taste. The alternative ingredient is a different ingredient in the sense that it is not in the same item category (e.g., milk, eggs, beef, chicken, etc.) as the ingredient. In contrast, a conventional online platform may offer an option to request a substitute item for a food item (e.g., Island Eggs, 1 dozen) but the provided substitute items in these cases have the same category (eggs) as the food item, but have a different brand (e.g., Farm Hills Free Range eggs, 1 dozen), a different quantity (e.g., Island Eggs, 1 half-dozen), etc. Also, as the substitute item provided by the conventional system is of the same category as the original food item, the substitute item would not change recipe type.

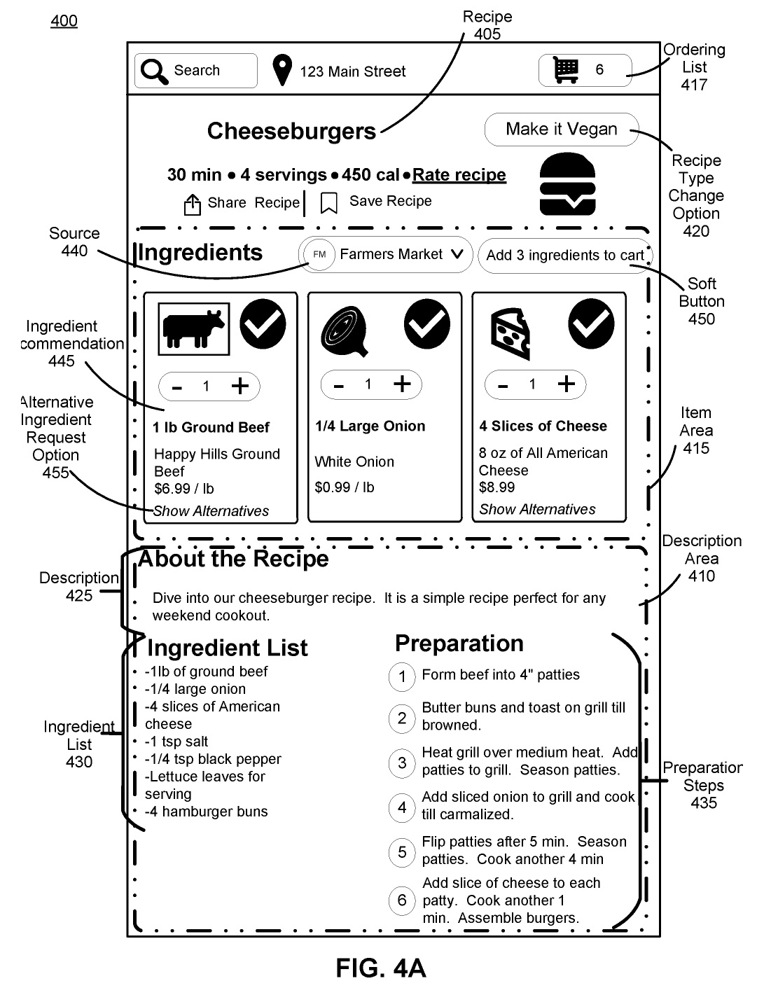

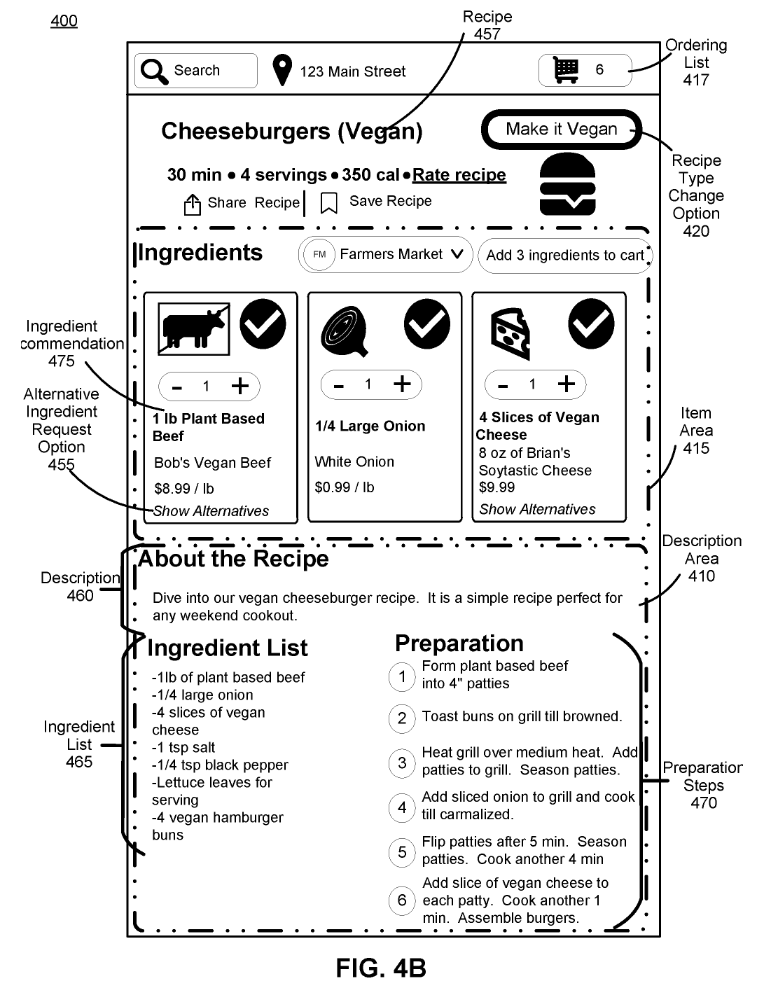

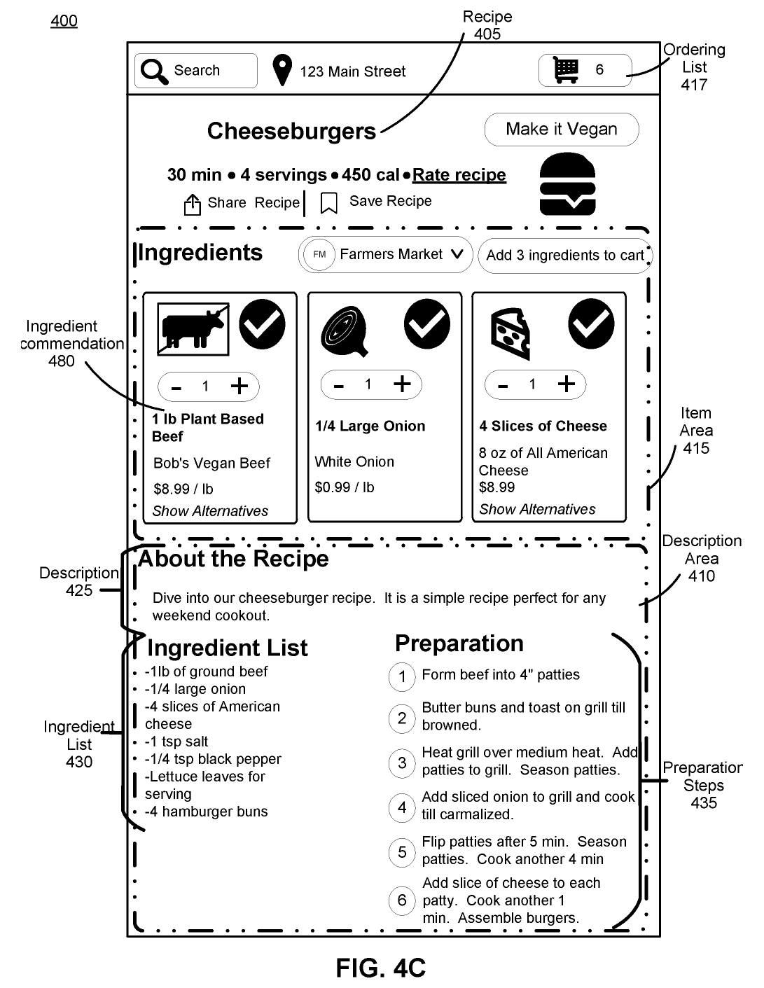

In some embodiments, the ordering interface may present a recipe along with one or more options (e.g., soft button, link, etc.) to change a type of the recipe to one or more other types or request alternative ingredient(s) for one or more of the ingredients of the recipe. For example, the options may be soft buttons for adjusting a type of a displayed recipe to one or more other types (e.g., pescatarian, vegetarian, gluten-free, etc.). Responsive to selection of one of the options (e.g., associated with a first type that is different from the type of the recipe), the user client device 100 instructs the online system 140 to adjust the recipe to the first type and provide the adjusted recipe to the user client device 100. The user client device 100 receives the adjusted recipe and presents (e.g., via the ordering interface) the adjusted recipe. Some examples of the ordering interface are shown and described below with regard to FIGS. 4A-B .

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface). In some embodiments, the user client device 100 may also provide feedback to the online system 140. Feedback in this context describes user perceived performance of the online system 140 in determining alternative ingredients or adjusting the recipe to be of a different type. For example, feedback may include, e.g., a user rating of a recipe adjusted to be of a particular type, a user rating of an alternative ingredient provided in response to request from the user, etc. In some embodiments, the user client device 100 may provide as part of the interface a rating option by which the user can provide the feedback. The user client device 100 may provide the feedback to the online system 140.

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

In some embodiments, a food item of an order from a user may not be available at a source location. The picker may use the picker client device 110 to notify the online system 140 of the unavailable item. The unavailable item may correspond to, e.g., an ingredient of a recipe that the user intends to make using food items in the order. In some embodiments, the online system 140 may provide one or more food items that are alternative ingredients that the picker may collect in lieu of the unavailable food item. In some embodiments, the user may have pre-authorized the picker to collect a food item that is an alternative ingredient in the event a food item that is an ingredient to a recipe is unavailable. In other embodiments, in the event that a food item that is an ingredient to a recipe is unavailable, the picker client device 110 or the online system 140 may contact the user client device 100 to receive approval to collect a food item that is an alternative ingredient to the ingredient.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The AI system 125 may be configured to apply inputs (e.g., prompts) to one or more machine-learning models to generate responses to the prompts. As used herein, machine-learning model is used interchangeably with "large language model." The AI system 125 includes one or more machine-learning models. The one or more machine-learning models may be generative machine-learning models.

The AI system 125 may be configured to determine one or more alternative ingredients for one or more ingredients of a recipe or adjust a recipe to be of a different type. For example, the AI system 125 may receive a prompt to identify an alternative ingredient for an ingredient of a recipe. The AI system 125 may apply the prompt to a large language model to determine one or more alternative ingredients for the ingredient of the recipe. In another example, the AI system 125 may receive a prompt to adjust a type associated with the recipe to a different type. The AI system 125 may apply the prompt to a large language model to determine the adjusted recipe. The large language model outputs recipe data that includes the one or more alternative ingredients, and may also include other information (e.g., updated ingredient list, updated preparation steps, etc.) specific to changing the recipe to the different type. The AI system 125 may provide the output of the large language model to the online system 140.

In one or more embodiments, at least some of the one or more machine-learning models are large language models (LLMs) that are trained on a large corpus of training data to generate outputs for the natural language processing (NLP) tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the AI system 125. An LLM may be trained on a large amount of data from various data sources. For example, the data sources include websites, articles, posts on the web, and the like. From this massive amount of data coupled with the computing power of LLM’s, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

The user client device 100, the picker client device 110, the source computing system 120, the AI system 125, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The online system 140 maintains an online catalog of items that are available for sale at various sources, including the grocery store source. The user client device 100 may present items from the online catalog that are associated with the grocery store source. The user may select, via the user client device 100, items from the online catalog. The user’s order may specify which groceries they want to be delivered from the grocery store and the quantities of each of the groceries. The user client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 stores recipe data for a plurality of recipes. The plurality of recipes is of different types. In some embodiments, some of the recipes are from one or more third party systems (not shown). Responsive to a request from the user client device 100, the online system 140 may retrieve recipe data for one or more recipes. Recipe data describes various aspects of one or more recipes. Recipe data for a recipe may include, e.g., preparation steps of the recipe, ingredients of the recipe, name of the recipe, type of the recipe, and other information like, e.g., recipe description, preparation time, calories, images associated with the recipe, etc. The online system 140 identifies food items in an online catalog that correspond to each of the ingredients of the one or more recipes. In some embodiments, the online system 140 may generate ingredient recommendations using the identified food items and the recipe data. An ingredient recommendation includes details of the food item (e.g., price, name, quantity, cost, etc.) in conjunction with some details of the ingredient (e.g., name, and amount called for by the recipe). The online system 140 provides some or all of the recipe data and the food items or the ingredient recommendations to the user client device 100.

The online system 140 may generate an interface (e.g., ordering interface for the user client device 100, the collection interface for the picker client device 110) that includes one or more options to change a type of a recipe or request an alternative ingredient for an ingredient of a recipe. The online system 140 provides the ordering interface to a user device (e.g., the user device 100). A user of the user device may select an option, and responsive to a selection of the option, the user device sends an instruction to the online system 140 to perform a function (e.g., determine an alternative ingredient for an ingredient, change type of a recipe) associated with the option.

The online system 140 may provide alternative ingredients to ingredients of recipes. For example, the online system 140 may receive, from the user device, an instruction to determine an alternative ingredient for an ingredient of a recipe. The online system 140 may generate, based in part on the instruction, a prompt to identify an alternative ingredient for the ingredient of the recipe. The online system 140 applies the prompt to a large language model to determine one or more alternative ingredients for the ingredient of the recipe. The large language model may output recipe data that includes the one or more alternative ingredients, and the recipe data may also include other details (e.g., ingredient list, preparation steps) affected by the substitution of the ingredient with the alternative ingredient. The online system 140 may determine one or more food items in the online catalog that correspond to the one or more alternative ingredients. In some embodiments, the online system 140 may determine ingredient recommendations that correspond to the one or more alternative ingredients using the one or more food items and recipe data. The online system 140 may provide the one or more food items or the ingredient recommendations to the user device.

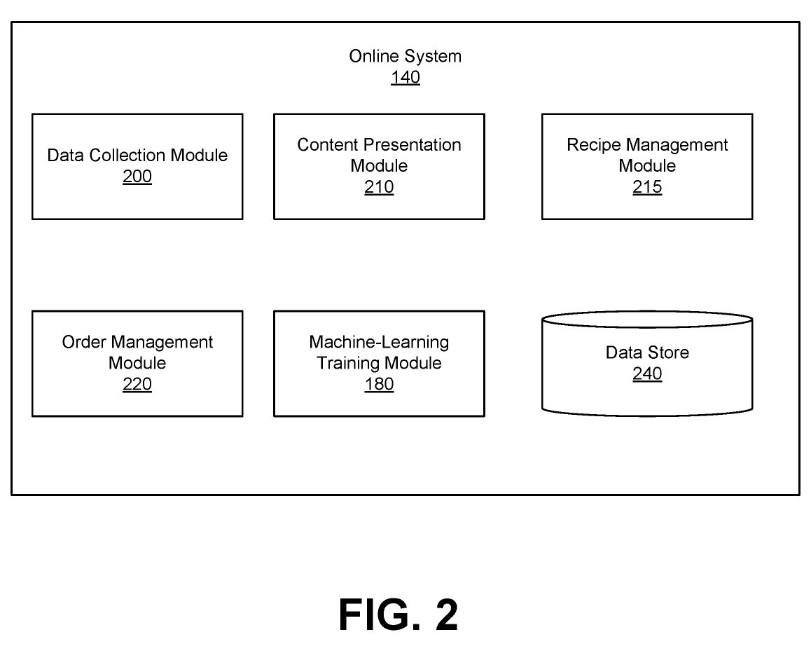

The online system 140 may adjust recipes to a particular type. For example, the online system 140 may receive, from a user device (e.g., the user client device 100), an instruction to change a type of a recipe to a particular type. For example, the user device may have presented an option to make a recipe Vegan, and responsive to a selection of the option, the user device sent the instruction to the online system 140. The online system 140 may generate, based in part on the instruction, a prompt to adjust the recipe to be of the particular type. The online system 140 may apply the prompt to a large language model to determine the adjusted recipe. The adjusted recipe includes a list of ingredients that is similar to the list of ingredients of the recipe, except one or more of the ingredients have been replaced with alternative ingredient(s) such that the recipe is of the particular type. The adjusted recipe may also include adjustments made to the preparation steps for the recipe based in part on the alternative ingredient(s). The adjusted recipe may also include other recipe data (e.g., preparation time, etc.), and in some embodiments, some or all of the other recipe data may also have been modified due to the recipe being adjusted to be of the particular type. The online system 140 may determine one or more food items in the online catalog that correspond to the ingredients in the adjusted recipe. In some embodiments, the online system 140 may determine ingredient recommendation using the one or more food items and recipe data for the adjusted recipe. The online system 140 may provide the one or more food items, the ingredient recommendations, recipe data for the adjusted recipe, or some combination thereof, to the user device. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, a recipe management module 214, a recipe recommendation module 215, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, user preferences (e.g., allergies, preferred sources, etc.), favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140. The data collection module 200 may also collect feedback from user client devices. The collected feedback describes user perceived performance of the online system 140 in determining alternative ingredients or adjusting the recipe to be of different types. For example, collected feedback may include, e.g., user ratings of recipes adjusted to be of various types, user ratings of alternative ingredients, etc.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The recipe management module 214 collects recipe data describing recipes from, e.g., the user client device 100, the source computing system 120, a third party system (e.g., website), an agent of the online system 140, or some combination thereof. Recipe data describes various aspects of a recipe. Recipe data for a recipe may include, e.g., preparation steps of the recipe, ingredients of the recipe, a name of the recipe, and other information like, e.g., a type of the recipe, a recipe description, preparation time, calories, images associated with the recipe, etc. The recipe management module 214 may identify food items in an online catalog of the online system 140 that correspond to each of the ingredients of some or all of the recipes. The recipe management module 214 may store the recipe data for the recipes in the data store 240.

In some embodiments, the recipe management module 214 may determine types of the collected recipes and associate those types with the recipes. In some embodiments, the recipe management module 214 may prompt a machine learning model of the AI system 125 to determine one or more types for some or all of the collected recipes. The recipe management module 214 may update the recipe data for some or all of the recipes with the determined types.

The recipe management module 214 may generate an interface that includes one or more options to change a type of a recipe or request an alternative ingredient for an ingredient of a recipe. The interface may be, e.g., a graphical user interface. The interface may be, e.g., a collection interface or an ordering interface. For example, the one or more options may be soft buttons, hyperlinks, etc. for requesting alternative ingredients or changes of type for recipe(s). An example interface is described below with regard to FIGS. 4A and 4B. The recipe management module 214 provides the interface to a user device (e.g., the user device 100). A user of the user device may select an option, and responsive to a selection of the option, the user device sends an instruction to the online system 140 to perform a function (e.g., request an alternative ingredient or change a type of recipe to some other type).

The recipe management module 214 receives, from user devices, instructions to determine alternative ingredients for ingredients of recipes or instructions to adjust types of recipes. The recipe management module 214 generates, based in part on the instructions, prompts for a large language model (e.g., of the AI system 125). A prompt may be, e.g., to identify one or more alternative ingredients for an ingredient of a recipe or to adjust a type of recipe to some other type (e.g., turning a vegetarian recipe vegan). The recipe management module 214 applies the prompts to the large language model (e.g., of the AI system 125). The large language model outputs based on the prompt, e.g., recipe data that includes alternative ingredients, and may include additional recipe data that has been adjusted based in part on a change of a type of the recipe to some other type.

The recipe recommendation module 215 may determine one or more food items in the online catalog that correspond to alternative ingredient(s) output by the large language model. The recipe recommendation module 215 may identify food items that correspond to the alternative ingredient(s). The recipe recommendation module 215 may rank the identified one or more food items for each of the alternative ingredient(s). The recipe recommendation module 215 may rank food items using ranking criteria. Ranking criteria may include, e.g., availability at sources, cost, amount of change to steps of recipe caused by use of food item, popularity of the food item in a context of the adjusted recipe, number of times the user has previously selected the food item, user data (e.g., user preferences (e.g., allergies, preferred sources, etc.)), some other criterion that may be used to rank the food item as an alternative ingredient, order data (e.g., number of times the user has previously ordered the food item), or some combination thereof. In embodiments, where there are multiple ranking criteria, the recipe recommendation module 215 may weight each of the ranking criteria, and then rank the one or more food items based on the weighted rankings. In some embodiments, the weights are equal for different ranking criteria. In other embodiments, at least one ranking criterion is weighted differently from another ranking criterion. In some embodiments, the recipe recommendation module 215 may select one or more of the highest ranked food items for an alternative ingredient. In some embodiments, the recipe recommendation module 215 generates ingredient recommendation(s) using the selected food item(s) and the recipe data. An ingredient recommendation includes details of the food item (e.g., price, name, quantity, cost, etc.) in conjunction with some details of the ingredient (e.g., name, and amount called for by the recipe). The recipe recommendation module 215 may provide selected food item(s), the ingredient recommendation(s), recipe data for the adjusted recipe, or some combination thereof, to the user device for presentation to the user.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. In some embodiments, the AI system 125 and its machine learning-models are part of the online system 140 and the machine-learning training module 230 may train those machine-learning models. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, recipe data, or order data, which may be referred to respectively as, training user data, training picker data, training item data, training recipe data, and training order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, the machine-learning training module 230 may train a machine-learning model (e.g., a large language model) to determine one or more alternative ingredients for the ingredient of the recipe. The machine-learning training module 230 may train the machine-learning model by accessing a set of training examples including recipe data, and may also include, e.g., user data, and item data. The machine-learning training module 230 may apply the large language model to the set of training examples to generate a training output corresponding to a set of predicted alternative ingredients. The set of predicted alternative ingredients corresponding to ingredients for various recipes or recipes that have been adjusted to be of a different type. The machine-learning training module 230 may back-propagate one or more error terms obtained from one or more loss functions to update a set of parameters of the large language model, and one or more of the error terms are based on a difference between a label applied to a test interaction of the set of training examples and the set of predicted alternative ingredients. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

For example, machine-learning training module 230 may retrain the large language model used by the AI system 125. The machine-learning training module 230 may receive feedback from user devices. The machine-learning training module 230 may determine additional training examples using recipe data (e.g., alternative ingredients) for recipes that were provided to the user devices and the feedback from the user devices regarding the provided recipe data for the recipes. The machine-learning training module 230 may retrain the large language model based in part on the additional training examples.

The data store 240 stores data used by the online system 140. For example, the data store 240 stores user data, item data, order data, recipe data, feedback from user devices regarding recipe data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

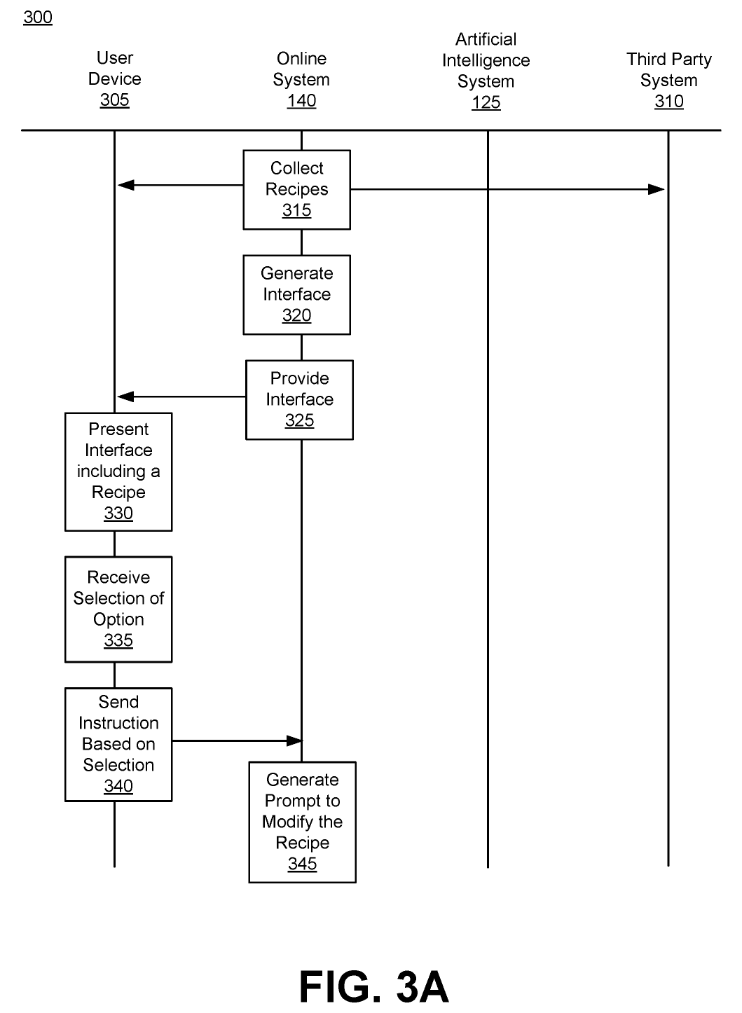

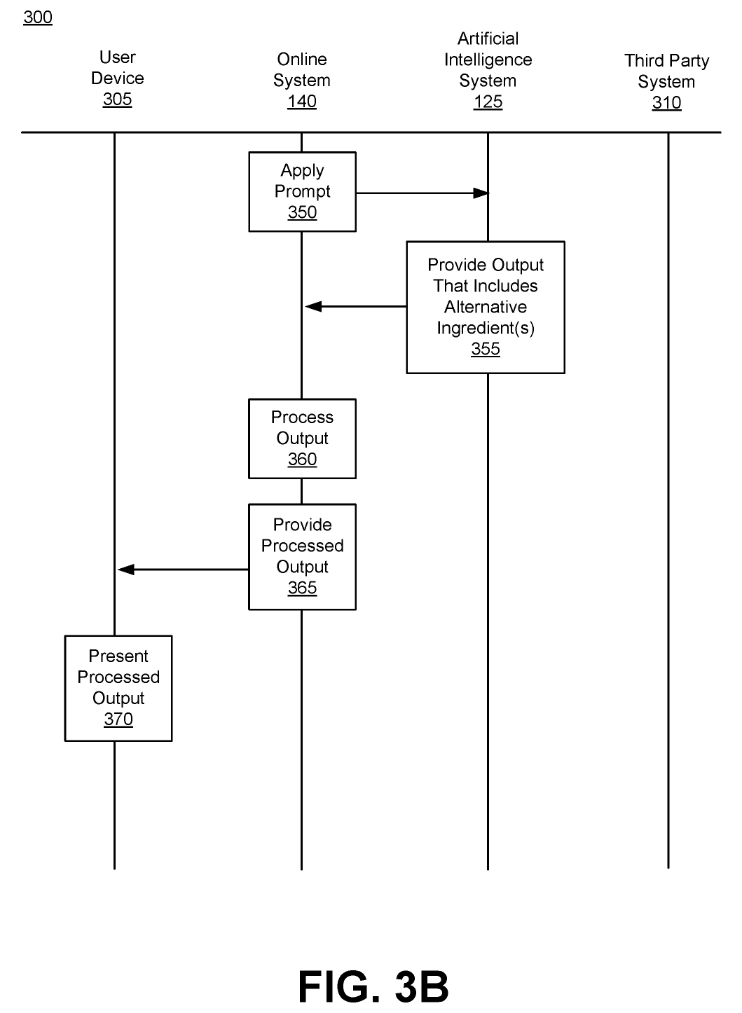

FIGS. 3A-3B form an example sequence diagram 300 describing leveraging a large language model for alternative ingredient determination, in accordance with some embodiments. Alternative embodiments may include more, fewer, or different interactions from those illustrated in FIGS. 3A-3B, and the steps may be performed in a different order from that illustrated in FIGS. 3A-3B. The sequence diagram 300 describes some actions of a user device 305, a third party system 310, the AI system 125, and the online system 140. The user device 305 is an embodiment of the user client device 100 or the picker client device 110. The third party system 310 is an embodiment of the third party system described above with regard to FIGS. 1 and 2. Alternative embodiments may include more, fewer, or different components from those illustrated in FIGS. 3A-3B, and the functionality of each component may be divided between the components differently from the description below. For example, some or all of the functionality of the AI system 125 may be performed by the online system 140.

The online system 140 collects 315 recipes data for a plurality of recipes. For example, the online system 140 may collect recipes from, e.g., the user device 305, the third party system 310, an agent (not shown) of the online system 140, or some combination thereof. The recipe data collected for a recipe may include, e.g., preparation steps of the recipe, ingredients of the recipe, name of the recipe, and other information like, e.g., type of the recipe, recipe description, preparation time, calories, images associated with the recipe, etc. In some embodiments, the collected recipe data may include types (e.g., vegan, vegetarian, low cholesterol, etc.) of the recipes. In some embodiments, the online system 140 may determine types of the recipe (e.g., by prompting a machine learning model of the AI system 125 to determine types for the collected recipes). The online system 140 may store the recipe data in a data store (e.g., the data store 240).

The online system 140 generates 320 an interface. The online system 140 may generate the interface (e.g., an ordering interface, a collection interface) in part using one or more of the collected recipes. In some embodiments, the online system 140 identifies food items in an online catalog that correspond to each of the ingredients of the one or more recipes. The online system 140 may generate ingredient recommendations (e.g., for presentation as part of the interface) for a recipe using the identified food items and recipe data associated with the recipe. The interface includes one or more options (e.g., soft button, hyperlink, etc.) to change a type of a recipe or request an alternative ingredient for an ingredient of a recipe. In some embodiments, a single option may be used to request alternative ingredients for a plurality of different ingredients of the recipe. The recipe online system 140 provides 325 the interface to the user device 305.

The user device 305 presents 330 the interface. The interface includes at least one recipe (of the collected recipes) and at least one of the one or more options. A presented recipe may include one or more ingredients or ingredient recommendations for the recipe. The interface presents one or more options to request alternative ingredients or presents one or more options to change a type of the recipe to one or more other types. The user device 305 receives 335 a selection of an option of the interface. The user device 305 sends 340 an instruction to the online system 140 to perform a function (e.g., request an alternative ingredient or change a type of recipe to some other type) associated with the selected option.

The online system 140 generates 345 a prompt to modify the recipe. The prompt is based in part on the instruction. For example, if the instruction requests an alternative ingredient for an ingredient of the recipe, the prompt may be to identify an alternative ingredient for the ingredient of the recipe. In other cases, if the instruction requests a change of the recipe to a first type, the prompt may be to change the recipe to be of the first type.

The online system 140 applies 350 the prompt to a large language model of the AI system 125. The large language model generates an output based on the prompt. The output includes one or more alternative ingredients, and may also include recipe data associated with the one or more alternative ingredients. In some embodiments, the one or more alternative ingredients are part of the recipe data for a recipe whose type has been adjusted to some other type. The AI system 125 provides 355 the output to the online system 140.

The online system 140 processes 360 the output. Processing the output may include, e.g., identifying food items in the online catalog that correspond to the one or more alternative ingredients in the output. The online system 140 may rank the identified one or more food items for each of the one or more alternative ingredients using one or more ranking criteria (e.g., availability, cost, etc.). In some embodiments, processing the output includes selecting for presentation to the user device 305, for each alternative ingredient, at least a highest ranked corresponding food item. Processing may also include generating ingredient recommendations using the food items corresponding to the one or more alternative ingredients and the recipe data. The online system 140 provides 365 the processed output to the user device 305.

The user device 305 presents 370 the processed output via the interface. For example, the interface may present an alternative ingredient for an ingredient, an ingredient recommendation for the alternative ingredient of the ingredient, some recipe data corresponding to the recipe being adjusted to another type (e.g., steps for the adjusted recipe, quantities of ingredients and alternative ingredients, a name of the adjusted recipe, a type of the adjusted recipe, etc.), or some combination thereof.

In the above manner, the online system 140 is able to quickly customize a recipe to tastes of a user using the large language model. Moreover, the customization can occur before the user adds food items to their ordering list for purchase.

FIG. 4A illustrates an example ordering interface 400 associated with a recipe 405, in accordance with some embodiments. In the illustrated embodiment the recipe 405 is for “Cheeseburgers.” In other embodiments, the recipe 405 may be some other recipe. The ordering interface 400 is an embodiment of the interface described above with regard to FIGS. 1, 2, 3A and 3B. The ordering interface 400 may be presented on a user device (e.g., the user client device 100). The ordering interface 400 is a user interface that presents item recipe data for the recipe 405 and ingredient recommendations relating to the recipe 405 that are available to purchase from a source (e.g., Farmers Market). In the illustrated embodiment, the ordering interface 400 includes a description area 410, an item area 415, and a recipe type change option 420. In other embodiments, the ordering interface 400 includes different or additional elements. In addition, the functions may be distributed among the elements in a different manner than described.

The description area 410 presents recipe data associated with the recipe 405. The description area 410 includes a description 425 of the recipe 405, an ingredient list 430 for the recipe 405, and preparation steps 435 for the recipe 405. The description 425 is a brief description of the recipe 405. The ingredient list 430 lists the ingredients and quantities of the ingredients for the recipe 405. The preparation steps 435 describe steps to prepare the recipe 405.

The item area 415 presents information describing ingredient recommendations that are for food items that are for sale from a source and that are ingredients (or alternative ingredients) of the recipe 405. In the illustrated embodiment, a user can change which source is associated with the ingredient recommendations using a source selector 440. For example, the user may use the source selector 440 to change the source for the ingredient recommendation from Farmers Market to some other source (e.g., one previously used by the user, within a threshold distance to the user, etc.). While in FIG. 4A the item area 415 is presenting item recommendations. In other embodiments, the item area 415 may present food items. A presented food item may be similar to an item recommendation, but does not include information about the recipe 405.

The item area 415 presents a plurality of ingredient recommendation based in part on the recipe data. The ordering interface 400 receives ingredient recommendations (or in some embodiments food items) from the online system 140 and presents them as part of the item area 415. Embodiments of the ingredient recommendations as illustrated include information describing an ingredient (e.g., amount of ingredient specified by ingredient list 430) of the recipe 405 as well as a food item corresponding to the ingredient. In some embodiments, the item area 415 only includes ingredient recommendations or food items that are ingredients (or alternative ingredients) of the recipe 405, but have not been added to the ordering list 417. For example, the ordering list 417 as illustrated includes 6 food items which do not include at least ground beef, white onion, and American cheese, which are all ingredients for the recipe 405. In other embodiments, the item area 415 includes ingredient recommendations for all ingredients of the recipe 405 without regard to food items previously added to the ordering list 417.

One or more ingredient recommendations may be selected, and then added to the ordering list using a soft button 450. For example, in the illustrated embodiments three of the ingredient recommendations are selected, such that all three may be added to the ordering list 417 via the soft button 450. In FIG. 4A the ingredient recommendation has been selected, but have not yet been added to the ordering list 417.

One or more of the ingredient recommendations may include an option to request an alternative ingredient. For example, the ingredient recommendations in FIG. 4A include an ingredient recommendation 445. The ingredient recommendation 445 includes an alternative ingredient request option 455. A user may select the alternative ingredient request option 455 to request one or more alternative ingredients be presented in lieu of (or in addition to) the ingredient (i.e., ground beef) corresponding to the ingredient recommendation 445. In the illustrated embodiment, the alternative ingredient request option 455 is a hyperlink titled "Show Alternatives." In other embodiments, the alternative ingredient request option 455 may take some other form (e.g., soft button). An alternative ingredient is different from an ingredient of a recipe but has a common purpose with the ingredient in a context of the recipe. As such, in the context of ground beef specified as an ingredient for cheeseburgers, alternative ingredients may be, e.g., ground turkey, ground chicken, etc. In some embodiments (not shown), a user may select a plurality of ingredient recommendations and request alternative ingredients for each of their corresponding ingredients via selection of a single option.

The recipe type change option 420 is an option to request a change of type of the recipe 405 to some other type. For example, in FIG. 4A, the recipe type change option 420 provides an option for a user to change the recipe for Cheeseburgers to a Vegan version. While a single recipe type change option is illustrated in FIG. 4A, in other embodiments there may be a plurality of recipe type change options for a recipe, where each of the plurality of recipe type change options is for a different type. In the illustrated embodiment, the recipe type change option 420 is a soft button. In other embodiments, the recipe type change option 420 may take some other form (e.g., hyperlink).

The ordering interface 400 facilitates a user being able to quickly modify a recipe to their specific diet. The ordering interface 400 may provide options to individually swap out specific ingredients with alternative ingredients. For example, a user of the ordering interface 400 may request (e.g., by selecting a corresponding alternative ingredient request option) from the online system 140 an alternative ingredient for an ingredient of the recipe 405. Moreover, the ordering interface 400 may provide options to modify the recipe 405 in its entirety to be of some other type (e.g., via selection of a recipe type change option). For example, a user of the ordering interface 400 may request (e.g., by selecting a corresponding alternative ingredient request option) from the online system 140 to adjust a recipe to a different type.

FIG. 4B illustrates the ordering interface 400 of FIG. 4A after selection of the recipe type change option 420. In the illustrated embodiment, the recipe type change option 420 of FIG. 4A was selected. The user device sent an instruction to the online system 140 requesting that the recipe 405 be adjusted to a type (e.g., vegan) specified by the selected recipe type change option. Responsive to sending the instruction, the user device receives recipe data ingredient recommendations and recipe data from the online system 140 that the user device uses to populate the interface 400.

The user device updates the ordering interface 400 using the ingredient recommendations and recipe data received from the online system 140. The received recipe data is for a recipe 457, which is the recipe 405 modified to be of a type associated with the selected recipe type change option 420. The user device updates, as needed, the description area 410 and the item area 415 to be in accordance with the recipe 457. For example, the description 425 is replaced with a description 460 that is based on the recipe 457, the ingredient list 430 is replaced with an ingredient list 465 that is based on the recipe 457, and the preparation steps 435 is updated with preparation steps 470 for the recipe 457.

Likewise, the item area 415 may be updated based on the recipe 457, and in some cases, items that have been added to the ordering list 417. Several of the ingredient recommendations in the item area 415 of FIG. 4A have been replaced with corresponding alternative ingredient recommendations in the item area 415 of FIG. 4B. For example, the ingredient recommendation 445 (e.g., for Happy Hills Ground Beef) is replaced with an ingredient recommendation 475 (e.g., for Bob's Vegan Beef). Ingredient recommendations may also include options to request alternative ingredients (e.g., the alternative ingredient request option 455).

FIG. 4C illustrates the ordering interface 400 of FIG. 4A after selection of the alternative ingredient request option 455. In the illustrated embodiment, the alternative ingredient request option 455 of FIG. 4A was selected for the ingredient recommendation 445. The user device sent an instruction to the online system 140 requesting that the online system 140 provide one or more alternative ingredients to an ingredient (e.g., for ground beef) associated with the ingredient recommendation 445. Responsive to sending the instruction, the user device receives from the online system 140 one or more ingredient recommendations for alternative ingredients for the ingredient.

In the illustrated embodiments, the description area 410 is unchanged. In other embodiments, the user device may update the description area 410 based in part on the alternative ingredient. For example, the user device may update the ingredient list 430 or the preparation steps 435 to reflect use of the alternative ingredient.

The user device updates the item area 415 using at least one of the received ingredient recommendations for the one or more alternative ingredients. For example, the ingredient recommendation 445 of FIG. 4A has been replaced with an ingredient recommendation 480 in FIG. 4C, where the ingredient recommendation 480 is for an alternative ingredient. In some embodiments, ingredient recommendations for alternative ingredients received from the online system 140 may be ranked. In some embodiments, the user device selects a highest ranked ingredient recommendation for an alternative ingredient, and presents the highest ranked ingredient recommendation in the item area 415.

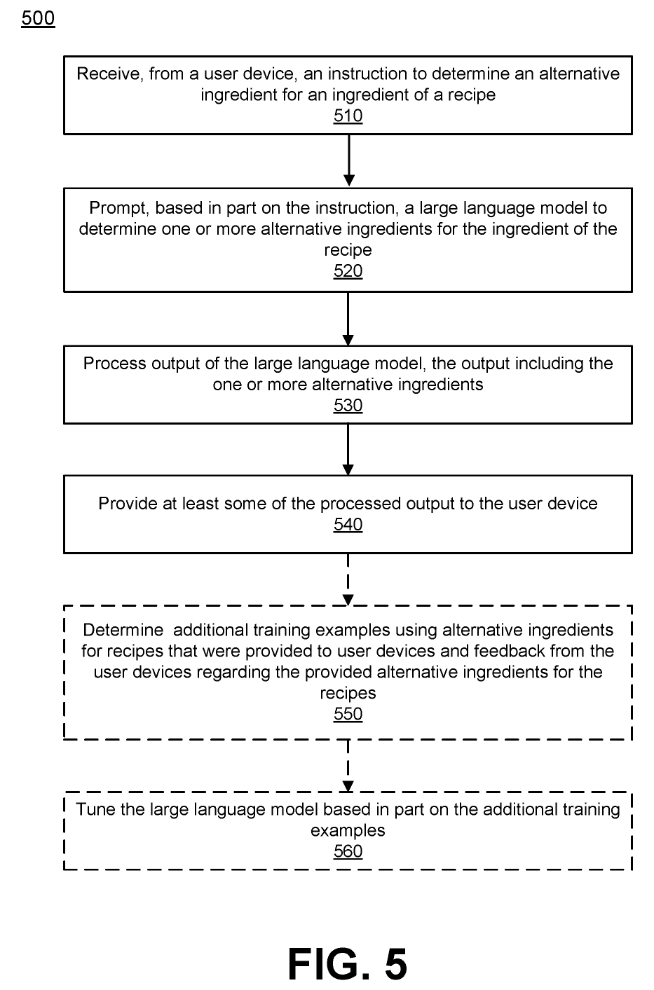

FIG. 5 is a flowchart 500 for a method of leveraging a large language model for alternative ingredient determination, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system receives 510, from a user device, an instruction to determine an alternative ingredient for an ingredient of a recipe. The alternative ingredient is different from the ingredient, but has a common purpose with the ingredient in a context of the recipe. For example, the online system may generate an interface that presents the recipe and an option to request an alternative ingredient for the ingredient, and in some embodiments, may also include an option to change a type of the recipe to a first type. The online system provides the interface to the user device, wherein the user device presents the graphical user interface including the option. Responsive to selection of the option, the user device sends the instruction to the online system.

The online system prompts 520 a large language model to determine one or more alternative ingredients for the ingredient of the recipe. The online system 140 may generate a prompt to modify the recipe (e.g., request an alternative ingredient or request an adjustment of the recipe to a different type). The prompt is based in part on the instruction. For example, if the instruction requests an alternative ingredient for an ingredient of the recipe, the prompt may be to identify an alternative ingredient for the ingredient of the recipe. In other cases, if the instruction requests a change of the recipe to a first type, the prompt may be to change the recipe to be of the first type. The online system may apply the prompt to a machine-learning model (e.g., large language model) of the AI system 125 or the online system 140. The machine-learning model generates an output based on the prompt. The output includes recipe data that includes one or more alternative ingredients.

The online system processes 530 outputs of the large language model, the output including the one or more alternative ingredients. Processing the output may include, e.g., identifying food items in an online catalog of the online system that correspond to alternative ingredients in the output. The online system 140 may rank the identified one or more food items for each of the alternative ingredients using one or more ranking criteria (e.g., order data (previously ordered), user data (e.g., preferences), availability, cost, etc.). In some embodiments, processing the output includes selecting (e.g., based on the ranking), for each alternative ingredient, a corresponding food item. Some or all of the selected food items may be provided to the user device for presentation. Processing may also include generating ingredient recommendations using the food items corresponding to the alternative ingredients and the recipe data.

The online system provides 540 at least some of the processed output to the user device. For example, the online system may provide one or more food items or ingredient recommendations that are alternative ingredients to the ingredient to the user device. The user device presents the one or more food items or ingredient recommendations. In some embodiments, the user client device presents the one or more food items or ingredient recommendations in lieu of the ingredient.

In some embodiments, the online system may determine 550 additional training examples using alternative ingredients for recipes that were provided to user devices and feedback from the user devices regarding the provided alternative ingredients for the recipes. The feedback may include, e.g., ratings of a recipe adjusted to be of a particular type, ratings of an alternative ingredient provided in response to requests from users, etc. In some embodiments, the received feedback may also include feedback from the user device regarding the processed output provided to the user device. The online system may then tune 560 the large language model based in part on the additional training examples. For example, the online system may use a machine-learning training module (e.g., the machine learning training module 230) to tune the parameters of the large language model, for example by using the prompt from the training examples as a prefix and the user-confirmed substitute items as a suffix for re-training the large language model. Alternatively, the online system may use prompt tuning during subsequent uses of the large language model.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, the method comprising:
sending, to a user device, a user interface that identifies a recipe and lists a plurality of ingredients for the recipe, wherein the user interface includes a user-selectable option to add one or more of the plurality of ingredients to an order;
receiving an instruction to identify an alternative ingredient to substitute for a particular ingredient of the plurality of ingredients of the recipe;
generating a prompt for a large language model, wherein the prompt includes:
a description of the recipe,
a description of the particular ingredient to be substituted, and
a request to suggest a different ingredient to substitute for the particular ingredient in the recipe;
providing the prompt to the large language model to obtain an output therefrom;
parsing, from the output of the large language model, the alternative ingredient for the recipe;
updating the user interface, wherein the updated user interface includes the alternative ingredient; and
sending, to the user device, the updated user interface, wherein the user device presents the updated user interface with the user-selectable option to add one or more of the plurality of ingredients, including the alternative ingredient, to an order.

2. The method of claim 1, wherein sending the user interface that identifies a recipe and lists a plurality of ingredients for the recipe comprises including, in the user interface, a selectable interface element to change a dietary attribute of the recipe.

3. The method of claim 2, further comprising:
receiving a selection of the selectable interface element to change a dietary attribute of the recipe;
wherein generating the prompt for the large language model comprises including, in the prompt, a request to suggest the different ingredient to substitute for the particular ingredient in the recipe in a way that is consistent with the request to change a dietary attribute of the recipe.

4. The method of claim 2, further comprising:
receiving a selection of the selectable interface element to change a dietary attribute of the recipe; and
generating an initial prompt for the large language model, wherein the initial prompt includes a description of the recipe, a list of the plurality of ingredients for the recipe, and a request to identify which of the plurality of ingredients are inconsistent with the request to change a dietary attribute of the recipe;
wherein receiving the instruction to identify the alternative ingredient for a particular ingredient of the plurality of ingredients of the recipe comprises parsing a response of the large language model to the initial prompt to identify the particular ingredient to be substituted with the alternative ingredient.

5. The method of claim 1, further comprising:
receiving, from the user device, a selection of the user-selectable option to add one or more of the plurality of ingredients, including the alternative ingredient, to an order;
identifying a plurality of items in an online catalog that correspond to each of the plurality of ingredients; and
sending, to the user device, a confirmation interface that includes a user-selectable option to confirm an order for the plurality of items, wherein the user device displays the confirmation interface.

6. The method of claim 1, wherein generating the prompt for the large language model comprises:
including, in the prompt, a request for a textual explanation about why the different ingredient is a suitable substitute for the particular ingredient in the recipe.

7. The method of claim 6, wherein updating the user interface comprises:
parsing, from the output of the large language model, the textual explanation about why the different ingredient is a suitable substitute for the particular ingredient in the recipe; and
including, in the updated user interface, the textual explanation about why the different ingredient is a suitable substitute for the particular ingredient in the recipe.

8. The method of claim 1, further comprising:
logging a user interaction with the updated user interface, the logged user interaction including an indication about whether the user-selectable option to add one or more of the plurality of ingredients, including the alternative ingredient, to an order was selected;
adding the logged user interaction to a set of training examples; and
tuning the large language model using the set of training examples.

9. A computer program product comprising a non-transitory computer readable storage medium having instructions encoded thereon that, when executed by a processor of a computer system, cause the computer system to perform steps comprising:
sending, to a user device, a user interface that identifies a recipe and lists a plurality of ingredients for the recipe, wherein the user interface includes a user-selectable option to add one or more of the plurality of ingredients to an order;
receiving an instruction to identify an alternative ingredient to substitute for a particular ingredient of the plurality of ingredients of the recipe;
generating a prompt for a large language model, wherein the prompt includes:
a description of the recipe,
a description of the particular ingredient to be substituted, and
a request to suggest a different ingredient to substitute for the particular ingredient in the recipe;
providing the prompt to the large language model to obtain an output therefrom;
parsing, from the output of the large language model, the alternative ingredient for the recipe;
updating the user interface, wherein the updated user interface includes the alternative ingredient; and
sending, to the user device, the updated user interface, wherein the user device presents the updated user interface with the user-selectable option to add one or more of the plurality of ingredients, including the alternative ingredient, to an order.

10. The computer program product of claim 9, wherein sending the user interface that identifies a recipe and lists a plurality of ingredients for the recipe comprises including, in the user interface, a selectable interface element to change a dietary attribute of the recipe.

11. The computer program product of claim 10, further comprising encoded instructions that when executed cause the computer system to perform steps comprising:
receiving a selection of the selectable interface element to change a dietary attribute of the recipe;
wherein generating the prompt for the large language model comprises including, in the prompt, a request to suggest the different ingredient to substitute for the particular ingredient in the recipe in a way that is consistent with the request to change a dietary attribute of the recipe.

12. The computer program product of claim 10, further comprising encoded instructions that when executed cause the computer system to perform steps comprising:
receiving a selection of the selectable interface element to change a dietary attribute of the recipe; and
generating an initial prompt for the large language model, wherein the initial prompt includes a description of the recipe, a list of the plurality of ingredients for the recipe, and a request to identify which of the plurality of ingredients are inconsistent with the request to change a dietary attribute of the recipe;
wherein receiving the instruction to identify the alternative ingredient for a particular ingredient of the plurality of ingredients of the recipe comprises parsing a response of the large language model to the initial prompt to identify the particular ingredient to be substituted with the alternative ingredient.

13. The computer program product of claim 9, wherein the encoded instructions for processing output of the large language model, the output including the one or more alternative ingredients cause the computer system to perform steps comprising:
receiving, from the user device, a selection of the user-selectable option to add one or more of the plurality of ingredients, including the alternative ingredient, to an order;
identifying a plurality of items in an online catalog that correspond to each of the plurality of ingredients; and
sending, to the user device, a confirmation interface that includes a user-selectable option to confirm an order for the plurality of items, wherein the user device displays the confirmation interface.

14. The computer program product of claim 9, wherein generating the prompt for the large language model comprises:
including, in the prompt, a request for a textual explanation about why the different ingredient is a suitable substitute for the particular ingredient in the recipe.

15. The computer program product of claim 14, wherein updating the user interface comprises:
parsing, from the output of the large language model, the textual explanation about why the different ingredient is a suitable substitute for the particular ingredient in the recipe; and
including, in the updated user interface, the textual explanation about why the different ingredient is a suitable substitute for the particular ingredient in the recipe.

16. The computer program product of claim 9, wherein the encoded instructions for processing output of the large language model, the output including the one or more alternative ingredients cause the computer system to perform steps comprising:
logging a user interaction with the updated user interface, the logged user interaction including an indication about whether the user-selectable option to add one or more of the plurality of ingredients, including the alternative ingredient, to an order was selected;
adding the logged user interaction to a set of training examples; and
tuning the large language model using the set of training examples.

17. A computer system comprising:
a processor; and
a non-transitory computer readable storage medium having instructions encoded thereon that, when executed by the processor, cause the computer system to perform steps comprising:
sending, to a user device, a user interface that identifies a recipe and lists a plurality of ingredients for the recipe, wherein the user interface includes a user-selectable option to add one or more of the plurality of ingredients to an order;
receiving an instruction to identify an alternative ingredient to substitute for a particular ingredient of the plurality of ingredients of the recipe;
generating a prompt for a large language model, wherein the prompt includes:
a description of the recipe,
a description of the particular ingredient to be substituted, and
a request to suggest a different ingredient to substitute for the particular ingredient in the recipe;
providing the prompt to the large language model to obtain an output therefrom;
parsing, from the output of the large language model, the alternative ingredient for the recipe;
updating the user interface, wherein the updated user interface includes the alternative ingredient; and
sending, to the user device, the updated user interface, wherein the user device presents the updated user interface with the user-selectable option to add one or more of the plurality of ingredients, including the alternative ingredient, to an order.

18. The computer system of claim 17, wherein sending the user interface that identifies a recipe and lists a plurality of ingredients for the recipe comprises including, in the user interface, a selectable interface element to change a dietary attribute of the recipe.

19. The computer system of claim 18, further comprising encoded instructions on the non-transitory computer readable storage medium that when executed cause the computer system to perform steps comprising:
receiving a selection of the selectable interface element to change a dietary attribute of the recipe;
wherein generating the prompt for the large language model comprises including, in the prompt, a request to suggest the different ingredient to substitute for the particular ingredient in the recipe in a way that is consistent with the request to change a dietary attribute of the recipe.

20. The computer system of claim 18, further comprising encoded instructions on the non-transitory computer readable storage medium that when executed cause the computer system to perform steps comprising:
receiving a selection of the selectable interface element to change a dietary attribute of the recipe; and
generating an initial prompt for the large language model, wherein the initial prompt includes a description of the recipe, a list of the plurality of ingredients for the recipe, and a request to identify which of the plurality of ingredients are inconsistent with the request to change a dietary attribute of the recipe;
wherein receiving the instruction to identify the alternative ingredient for a particular ingredient of the plurality of ingredients of the recipe comprises parsing a response of the large language model to the initial prompt to identify the particular ingredient to be substituted with the alternative ingredient.
